(19) United States
(12) Patent Application Publication
(10) Pub. No.: US 2006/0003071 A1
(43) Pub. Date: Jan. 5, 2006

(54) Low carbohydrate snack and method for making

(76) Inventors: Pierre Faa, Frisco, TX (US); James William Stalder, Dallas, TX (US)

Correspondence Address: CARSTENS & CAHOON, LLP, P O BOX 802334, DALLAS, TX, 75380, US

(21) Appl. No.: 10/884,216

(22) Filed: Jul. 2, 2004

(51) Int. Cl. A21D 10/00

(52) U.S. Cl. 426/549

(57) ABSTRACT

A method for making a low carbohydrate, high protein corn tortilla-like snack food product. Ingredients comprising soy isolate, soy concentrate, fiber, corn masa, and water are combined to make a dough. The dough can then be cooked either by frying or baking, and seasoned to make a low carbohydrate tortilla-like snack food.

### BACKGROUND OF THE INVENTION

1. Technical Field

The present invention relates to the production of a low carbohydrate sheetable dough that can be made into a shelf stable snack food with minimal reduction of organoleptical properties.

2. Description of Related Art

Shelf stable snack food products such as tortilla chips are popular consumer items for which there exists a great demand. Tortilla chips are typically made from corn. The corn from corn tortilla chips such as those in the snack food industry is sometimes cooked and soaked prior to being made into a flour, dough, or masa. One example of this process is the treatment of corn in nixtamalization process—the traditional method for processing fresh corn to form masa dough. This process dates back to the pre-Columbian era of the Aztec and Mayan people in Mesoamerica. In the traditional nixtamalization process, fresh whole-kernel corn is first soaked in a solution of water and lime (calcium hydroxide) and partially cooked at or near the boiling point for a short time depending on the hardness of the corn. The corn is then steeped in the limewater solution and is allowed to cool for about 8-18 hours in order to loosen and degrade the pericarp (or bran), which is the outer, fibrous layer of a corn kernel. Cooking and steeping in alkaline solution causes partial dissolution of the cuticle and other pericarp layers as well as swelling and weakening of cell walls and fiber components. The corn kernels are then drained of the cooking liquor (called “nejayote”), which contains loosened pericarp and other dissolved or suspended particles, and the corn kernels are washed to remove excess lime and loose particles. Typically, up to 15% by weight of the total corn fraction is lost during the cooking and washing steps. The corn kernels are then ground to disrupt the starch-containing cell. The ground, wet mixture can be mixed with water to form fresh masa dough, or it can be dehydrated to form dry masa flour. Dry masa flour can be rehydrated at a later time to form masa dough. Corn is a high carbohydrate food. A substantial amount of the calories in a traditional tortilla chip are sourced from the corn's carbohydrate content.

Recently, consumer demand for products low in carbohydrates has dramatically increased, as the popularity of low carbohydrate diets has increased. According to one recent newspaper account, 40% of consumers say they are watching their carbohydrate intake. There are currently numerous low carbohydrate diets being marketed to consumers. Such an example is exemplified by U.S. Pat. No. 5,855,949, which discloses a dietary system for the treatment of obesity that prescribes foods that are low in fats and carbohydrates, and which have moderate amounts of proteins. Unfortunately, the '949 patent fails to disclose a means for reducing carbohydrate intake from snack foods. U.S. Patent Application 2003/0108654 A1 discloses a dry mix and process for using said mix to make a low carbohydrate potato product. Dry mixes are not usually considered “ready to eat” foods, as water must first be added and the resulting dough composition mixed and cooked prior to consumption. In addition, the application indicates that the products made from the dry mix are not shelf stable unless dried. If the products are dried, though, they may not be ready to eat. Thus, the invention disclosed in the '654 application fails to provide a convenient, ready to eat, shelf-stable, and low carbohydrate snack food. Hence, there is a need for a convenient low carbohydrate shelf-stable, ready to eat snack food.

Many convenient, shelf-stable, ready to eat snack foods are high in carbohydrates. This reality makes it difficult for consumers to maintain a low carbohydrate diet. In addition, many consumers have become accustomed to supplementing their meals with convenient snack foods, making it more difficult to maintain a low carbohydrate diet.

One solution for a low carbohydrate snack food is illustrated in U.S. Pat. Nos. 6,291,009 and 6,479,089, which disclose a soy based dough and products made from the dough. These patents, however, disclose mixing dry ingredients including pre-gelatinized starch and, in some embodiments, dehydrated corn masa flour with water. Unfortunately, dehydrated corn masa flour can permanently lose some of the more volatile flavors during dehydration. Moreover, much of the flavor in traditional corn tortilla chips is created when corn is cooked in lime water. Thus, pre-gelatinized starch, which is not cooked in lime water, fails to deliver the superior flavor and texture that is provided by corn masa that consumers have come to expect.

Another attempt to solve this problem is disclosed in U.S. Patent Application No. 2003/0064145 A1, entitled “Puffed Protein Based Snack Food.” The '145 patent application discloses a low-density snack food comprising a solids matrix of protein, an optional carbohydrate filler, and a fat content not to exceed 30%. The taste and texture characteristics of this product, however, fail to mimic the taste and texture characteristics of a conventionally produced puffed snack product. For example, there is no discussion in the disclosure of how the off flavors known to inherently develop in extruded high protein compounds, were avoided. Moreover, this disclosure is directed towards direct expanded food products rather than tortilla-like snack products. Consequently, there is a need in the art for a process for manufacturing reduced carbohydrate snack product with taste and texture characteristics similar to conventionally produced snack products. Further, there is a need in the art for a process for manufacturing reduced carbohydrate tortilla-like snack product with taste and texture characteristics similar to conventionally produced corn tortilla snack products. The low carbohydrate snack food should emulate the organoleptical properties and appearance, including taste, texture, color and blister development of a conventionally produced corn tortilla snack product. The snack food should be shelf stable and ready to eat.

### SUMMARY OF THE INVENTION

The proposed invention provides a low carbohydrate snack food dough and method for making. In one embodiment, the invention uses a combination of soy proteins, namely soy concentrate and soy isolate, combined with corn masa made from a traditional nixtamalization process. The ingredients are mixed and hydrated to form a dough. The dough can be sheeted and cut into pre-forms, cooked, and seasoned. Oil spray and salt or seasoning can be applied to the cooked snack.

Hence, this invention produces a low carbohydrate snack food dough and method for making whereby a low carbohydrate snack is made that mimics the taste, texture and appearance characteristics of conventionally produced, high carbohydrate corn tortilla snack products. In addition, the low carbohydrate snack food is shelf stable and ready to eat. The above as well as additional features and advantages of the present invention will become apparent in the following written description.

### DETAILED DESCRIPTION

The low carbohydrate snack product of the present invention is prepared from protein, fiber and corn masa. In one embodiment, a corn masa made from a traditional nixtamalization process is used. The concentrated protein ingredients can comprise soy protein isolate or soy protein concentrate. Soy protein isolate, soy protein concentrate, fiber and corn masa are ingredients well known in the art. As used herein, net carbohydrates is synonymous with carbohydrate and is defined as a digestible carbohydrate. Dietary fiber is not a digestible carbohydrate. As used herein, dietary fiber and fiber are used interchangeably and include both soluble and insoluble fiber. Unless indicated otherwise, all percentages discussed herein are by weight.

Soy protein concentrate and soy protein isolate are prepared by removing most of the water soluble, non-protein (e.g., carbohydrate) constituents from dehulled and defatted soybeans. Soy protein isolate, for example, typically comprises 90% protein by weight, and has negligible dietary fiber and carbohydrates. Soy protein isolates, including PRO-FAM 780, 781, 825, 875, 929, 930, and 955 available from ADM, of Decatur, Ill., or SuproSoy 661 or 760 soy protein isolates from Solae Company, of St. Louis, Mo., or Prolisse 500 soy protein isolate from Cargill, of Minneapolis, Minn., can be used. As used herein, soy protein isolate is defined as a protein mixture derived from a soybean having at least 90% by weight wet basis by weight protein. Soy protein concentrate typically comprises 70% by weight protein, 20% by weight fiber, and has negligible carbohydrates. Soy protein concentrates, including ARCON F, VF and S, are available from ADM, of Decatur, Ill. As used herein, soy protein concentrate is defined as a protein mixture derived from a soybean having between about 65% by weight to about 70% by weight wet basis by weight protein.

Soy flour is typically made by grinding and screening soybean flakes either before or after removal of soybean oil. Soy flour typically comprises 50% by weight protein, 20% by weight fiber, and 10% by weight carbohydrates. As used herein, soy flour is defined as a ground soy derived from a soybean having less than about 65% wet basis by weight protein. It is preferable that soy protein isolate and soy protein concentrate be used rather than soy flour because of the higher protein contents in the soy isolate and soy concentrate. Use of soy flours can contribute to more apparent off-flavors.

Although soy-based proteins are disclosed in some embodiments of this invention, other protein sources can be used, either in lieu of, or in combination with the soy-based proteins including, but not limited to, dairy-based proteins, wheat-based proteins, rice-based proteins, potato-based proteins and egg-based proteins. Moreover, other legume-based protein sources other than soy can be used including, but not limited to, beans, lentils and peas. Soy-based proteins are currently most advantageous because of cost and functionality considerations.

A soy isolate blend can be used that minimizes stickiness and a beany flavor. For example, the soy isolate component of the present invention can comprise about two parts by weight soy protein isolate ProFam 929 for every about one part by weight soy protein isolate ProFam 781, both available from Archer Daniels Midland of Decatur, Ill. ProFam 929 soy protein isolate tends to be a process-friendly protein and helps to reduce stickiness of the dough that can result in problems at the sheeter. The soy protein isolate PROFAM 781 tends to have a less beany flavor. The combination of these two isolates can result in a synergistic soy isolate blend. Although soy isolate can be exclusively used, cost considerations can make other low carbohydrate ingredients such as soy concentrate, soy flour, soy grits, soy meal, and fiber desirable. Soy protein isolate comprises between 0% to about 100% by weight more preferably between about 25% to about 75% by weight of the dry ingredients.

Similarly, soy protein concentrate comprises between about 0% to about 100% by weight and more preferably between about 25% and about 75% by weight of the dry ingredients. A soy protein concentrate or soy protein concentrate blend that has a relatively low beany flavor and minimizes stickiness such as Arcon VF, available from Archer Daniels Midland can be used.

Fiber comprises between 0% and about 20% by weight and more preferably between 5% and 15% by weight of the dry ingredients. Fiber, including, but not limited to, oat fiber, bamboo fiber, potato fiber, corn bran, rice bran, and wheat bran can be used to reduce the amount of net carbohydrates in the resultant food product and can thus be added as ingredients without increasing carbohydrate content (as defined above in this application) of the food product. Higher levels of fiber can negatively impact finished product texture and flavor. More fiber can result in increased grittiness. Fiber is used because it is not a digestible carbohydrate and fiber also helps the finished product to be more resistant to breakage.

In one embodiment, following the addition of water to the dry ingredients to make a low carbohydrate dough, the resultant dough comprises about 15% to about 59% of soy isolate or soy concentrate, about 0% to about 20% fiber by weight, about 30% to about 50% by weight corn masa, and about 30% to about 50% by weight added water. The dough is mixed in a continuous batch or other mixer. In one embodiment, the mixing occurs at ambient temperature, generally about 60° F. to about 85° F. In one embodiment, following mixing, the dough is routed to a Kibbler device that breaks the dough into smaller dough pieces of less than about two inches in diameter to facilitate sheeting.

The dough can then be formed into pre-forms as any other snack food dough is processed in the art. For example, the dough can be extruded or sheeted and then cut into snack food pre-forms. The pre-forms can be toasted in a three-pass toast oven at between about 400° F. and about 750° F. for about 30 seconds to achieve a moisture content of between about 25% and about 40% by weight. The toasted per-forms can then be sent through a proofing stage where toasted pre-forms are exposed to ambient air for about 2 to 5 minutes to equilibrate moisture throughout the chip. The toasted pre-form can then be fried in a conventional tortilla chip fryer at about 340° F. to about 360° F. or other temperature until a moisture content of between about 0.8% to about 2.0% by weight and more preferably about 1.0% by weight is achieved. Higher temperatures provide a crispier texture, but temperatures too high can result in undesirable product browning. Lower temperatures may require more time in the toast oven. The fried snack chip can then be seasoned in a seasoning tumbler and then packaged.

### EXAMPLE

The table below illustrates the ingredients and their relative amounts that were used to make a low carbohydrate dough for producing a tortilla-like snack.

| | Wt % Dry | | Wt % Cheese |
|---|---|---|---|
| Ingredient | Ingredients | Wt % dough | Seasoned Snack |
| Corn Masa | — | 32% | 22% |
| Soy Isolate | 46% | 15% | 19% |
| Soy Concentrate | 44% | 14% | 18% |
| Oat Fiber | 10% | 3% | 4% |
| Added Water | — | 36% | 1% |
| Seasoning | — | — | 10% |
| Corn Oil | — | — | 26% |

In the above embodiment, dry ingredients comprising 46% soy isolate by weight, 44% soy concentrate (Arcon VF) by weight, and 10% by weight of oat fiber are added to non-dehydrated corn masa and water. The soy isolate component comprised a soy isolate blend having about 30% by weight of the dry ingredients ProFam 929 and about 16% by weight of the dry ingredients ProFam 781. The resultant dough mixture comprised about 32% by weight corn masa, about 15% by weight soy isolate blend, about 14% by weight soy concentrate, about 3% by weight oat fiber, and about 36% by weight added water. It should be noted that the non-dehydrated corn masa inherently comprises about 50% by weight moisture. The resultant dough mixture was mixed in a continuous batch mixer, then sheeted and cut into triangle-like pre-forms.

These pre-forms were toasted in a three-pass toast oven at a temperature of about 550° F. for about 30 seconds. The toasted pre-forms next went through a proofing stage where they were routed along a conveyor at ambient temperature for about two minutes prior to entry into the fryer. This proofing stage allowed moisture to equilibrate within the toasted pre-form. The toasted pre-forms were then fried in corn oil at a temperature of about 345° F. In one embodiment, the fried chips were routed to an oil spray and cheese flavored powder tumbler. In that embodiment, the resultant chip comprised about 22% corn masa by weight, 19% soy isolate by weight, 18% soy concentrate by weight, 4% oat fiber by weight, 1% added water by weight, 26% corn oil and about 10% seasoning by weight. In an alternative embodiment, the fried chips were oil sprayed and salted.

There are a number of advantages provided by the present invention. First, existing food-processing equipment from a traditional corn tortilla chip line, including cook kettles, sheeters, toast ovens, fryers, and seasoning tumblers can be used. Thus, a food product manufacturer of corn tortilla chips can easily use existing equipment in making this low carbohydrate dough. Second, a low carbohydrate snack food can be made. In one embodiment, a serving size contains only 6 grams of net carbohydrate, compared to a prior art snack having 16 grams of net carbohydrate, a reduction of about 62%. Third, this invention produces a low carbohydrate corn tortilla snack and method for making that mimics the taste, appearance and texture characteristics of conventionally produced, high carbohydrate corn snack products. Further, there is minimal off-flavor that is typically present in soy-based food products. In addition, the low carbohydrate snack food is shelf-stable and ready to eat.

While this invention has been particularly shown and described with reference to a preferred embodiment, it will be understood by those skilled in the art that various changes in form and detail may be made therein without departing from the spirit and scope of the invention.

1. A method for making a low carbohydrate snack, said method comprising the steps of:
a) mixing corn masa, dry ingredients, and water to make a dough, wherein said dough comprises:
about 15% to about 55% by weight of a concentrated protein, wherein said concentrated protein consists of soy protein concentrate, soy protein isolate, and mixtures thereof;
about 0% to about 20% by weight of a fiber;
about 30% to about 50% by weight of a non-dehydrated corn masa; and
about 30% to about 50% by weight added water;
b) forming a pre-form from said dough;
c) toasting said pre-form to make a toasted pre-form having a moisture content of between about 25% and about 40% by weight; and
d) frying said toasted pre-form to make a fried chip having a moisture content of between about 0.8% and about 2.0% by weight.

2. The method of claim 1 further comprising:
e) seasoning said fried chip.

3. The method of claim 2, wherein said fried chip comprises by weight:
about 15% to about 40% corn masa;
about 15% to about 40% soy isolate;
about 15% to about 40% soy concentrate;
about 0% to about 10% fiber;
about 20% to about 35% oil; and
about 1% to about 15% seasoning.

4. The method of claim 1, wherein said concentrated protein comprises a soy protein isolate blend.

5. The method of claim 1, wherein said concentrated protein comprises a soy protein concentrate blend.

6. A low carbohydrate snack food comprising by weight:
about 15% to about 40% corn masa;
about 15% to about 40% concentrated protein wherein said concentrated protein consists of soy protein isolate, soy protein concentrate, or mixtures thereof;
about 0% to about 10% fiber;
about 20% to about 35% oil; and
about 1% to about 15% seasoning.

7. The low carbohydrate snack food of claim 6 wherein said concentrated protein comprises a soy isolate blend.

8. The low carbohydrate snack food of claim 6 further wherein said concentrated protein comprises a soy concentrate blend.

9. A low carbohydrate dough comprising by weight:
about 30% to about 50% a non-dehydrated corn masa;
about 15% to about 55% soy isolate of a concentrated protein wherein said concentrated protein consists of soy protein isolate, soy protein concentrate, or mixtures thereof;
about 0% to about 20% fiber; and
about 30% to about 50% added water.

10. The low carbohydrate dough of claim 9 wherein said concentrated protein comprises a soy isolate blend.

11. The low carbohydrate dough of claim 9 further wherein said concentrated protein comprises a soy concentrate blend.

12. The low carbohydrate dough of claim 9 further comprising at least about 1% fiber.

13. The low carbohydrate snack food of claim 6 further comprising at least about 1% fiber.

14. The method of claim 1 wherein said dough further comprises at least about 1% of said fiber by weight.
